(19) United States
(12) Patent Application Publication
(10) Pub. No.: US 2025/0296383 A1
(43) Pub. Date: Sep. 25, 2025

(54) VEHICLE WHEEL STRUCTURE

(71) Applicant: TOYOTA JIDOSHA KABUSHIKI KAISHA, Aichi-ken (JP)

(72) Inventor: Tomoyuki ISHIKAWA, Nisshin-shi (JP)

(21) Appl. No.: 19/064,696

(22) Filed: Feb. 27, 2025

(30) Foreign Application Priority Data
Mar. 21, 2024 (JP) 2024-044707

(51) Int. Cl. B60B 7/00

(52) U.S. Cl. CPC B60B 7/002

(57) ABSTRACT

A vehicle wheel structure includes: a wheel; and a wheel mounting member. The wheel mounting member includes a diversion mechanism including a first member, a second member, an inlet provided to the first member to lead air into a space between the first member and the second member in an air opening provided to a disk having a plate shape, an obstruction section configured to obstruct a flow of the air led from the inlet, and an outlet provided to the second member to lead the air moved by the flow of air obstructed by the obstruction section to the outer side of the vehicle. The disk forms the wheel.

### CROSS-REFERENCE TO RELATED APPLICATION

This application claims priority to Japanese Patent Application No. 2024-044707 filed on Mar. 21, 2024, incorporated herein by reference in its entirety.

### BACKGROUND

### 1. Technical Field

The present disclosure relates to a vehicle wheel structure.

### 2. Description of Related Art

A vehicle wheel structure disclosed in Japanese Patent No. 6927079 has been known. The conventional vehicle wheel structure includes a resin wheel cap mounted on the outside of a wheel. Then, the wheel cap is provided with slits on the outer circumference of the wheel. The slits each allow air to flow from the inner side to the outer side of a vehicle.

### SUMMARY

Improving the aerodynamic characteristics of a traveling vehicle, that is, decreasing air resistance acting on a traveling vehicle, is important to increase the fuel efficiency or the electricity efficiency of the vehicle. The traveling vehicle normally has a side flow of air moving on a side surface of the vehicle from the front side to the rear side in the front-rear direction of the vehicle and a flow of air on the lower side of the vehicle body moving from the inner side to the outer side of the wheel.

Air moved by the flow of air directed from the inner side to the outer side of the wheel, however, disturbs the side flow and the disturbed side flow consequently increases the air resistance in some cases. In particular, in the conventional vehicle wheel structure described above, air moved toward the outer side and discharged from the wheel on the outer circumference side of the wheel spurs a vortex that is generated near the sidewall of the tire supported by the wheel closer to the outer side and disturbs the side flow in some cases. Reducing air discharged from the inner side to the outer side of the wheel is therefore important to decrease the air resistance.

An object of the present disclosure is to provide a vehicle wheel structure that makes it possible to reduce air discharged from the inner side to the outer side of a wheel.

An aspect of the present disclosure is a vehicle wheel structure. The vehicle wheel structure includes: a wheel configured to support a tire; and a wheel mounting member mounted on the wheel. The wheel is assembled into a vehicle. The wheel mounting member mounted on the wheel assembled into the vehicle includes a diversion mechanism. The diversion mechanism includes a first member, a second member, an inlet, an obstruction section, and an outlet. The first member is disposed on the inner side of the vehicle. The second member is disposed on the outer side of the vehicle with an interval to the first member. The inlet is provided to the first member to lead air to a space between the first member and the second member in an air opening provided to a disk having a plate shape. The disk forms the wheel. The air is moved by a flow of air directed from the inner side of the vehicle to the outer side of the vehicle. The obstruction section is configured to obstruct the flow of the air led from the inlet. The outlet is provided to the second member to lead the air moved by the flow of air obstructed by the obstruction section to the outer side of the vehicle.

The vehicle wheel structure according to the present disclosure allows the diversion mechanism provided to the wheel mounting member to obstruct, by the obstruction section, a flow of air led from an inlet 143 provided to the first member. That is, it is possible to weaken the flow of air by diverting the air and lead the air to the outer side from the outlet provided to the second member. This allows the vehicle wheel structure to restrain the air moved by the flow of air directed from the inner side to the outer side from spurring the formation of a vortex generated near the sidewall of the tire closer to the outer side by a traveling vehicle and consequently restrain the vortex from interfering with a side flow SF to disturb the side flow. The vehicle wheel structure is thus allowed to restrain air resistance acting on the traveling vehicle from increasing and consequently contribute to increases in the fuel efficiency and the electricity efficiency of the vehicle.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram for describing a vehicle wheel structure according to an embodiment;

FIG. 2 is a sectional view for describing the vehicle wheel structure;

FIG. 3 is a diagram for describing a wheel;

FIG. 4 is a diagram for describing a wheel mounting member;

FIG. 5 is a sectional view for describing a diversion mechanism;

FIG. 6 is a sectional view for describing a flow of air in a case where the wheel mounting member is not mounted;

FIG. 7 is a diagram for describing of diversion of air and discharge of air to an outer side by the wheel mounting member and the diversion mechanism;

FIG. 8 is a diagram for describing of diversion of air and discharge of air to a rear side by the wheel mounting member and the diversion mechanism;

FIG. 9 is a sectional view for describing a diversion mechanism according to a first modification example;

FIG. 10 is a sectional view for describing a diversion mechanism according to a second modification example;

FIG. 11 is a sectional view for describing a diversion mechanism according to a third modification example;

FIG. 12 is a diagram for describing a wheel mounting member and a diversion mechanism according to a fourth modification example;

FIG. 13 is a diagram for describing a wheel mounting member and a diversion mechanism according to a fifth modification example;

FIG. 14 is a diagram for describing a wheel mounting member and a diversion mechanism according to another modification example;

FIG. 15 is a diagram for describing a wheel mounting member and a diversion mechanism according to another modification example; and

FIG. 16 is a diagram for describing a wheel mounting member and a diversion mechanism according to another modification example.

### DETAILED DESCRIPTION OF EMBODIMENTS

Hereinafter, a vehicle wheel structure according to the present disclosure will be described in detail with reference to the drawings. It is to be noted that the present disclosure can be carried out in various forms in which various modifications and improvements are made based on the knowledge of those who skilled in the art in addition to the following embodiment and the like.

### 1. Embodiment

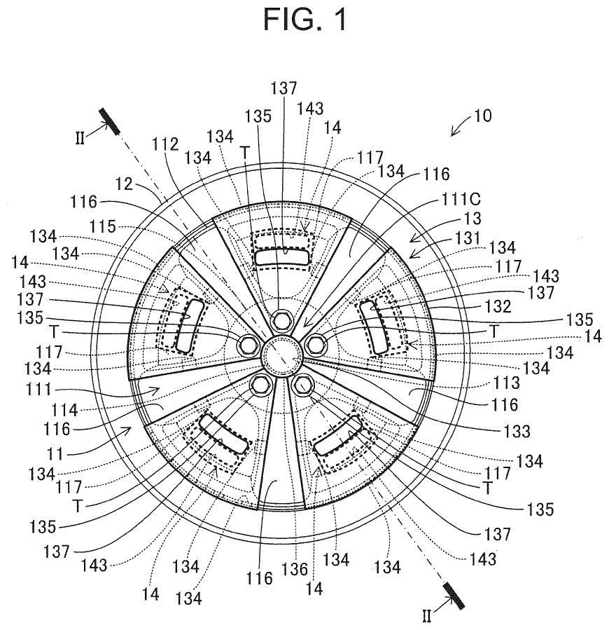

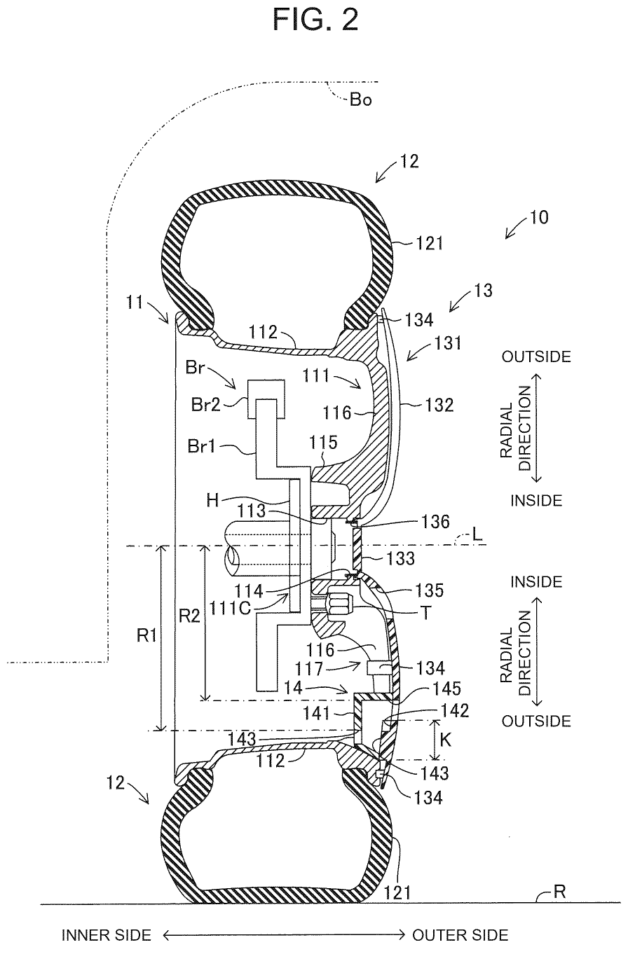

As illustrated in each of FIGS. 1 and 2, a vehicle wheel structure 10 according to the present embodiment includes a wheel 11 included in a tire-wheel assembly of a vehicle. The wheel 11 supports a tire 12 and is assembled into the vehicle. The vehicle wheel structure 10 according to the present embodiment then includes a wheel cover 13 as a wheel mounting member that is mounted on the wheel 11. Furthermore, the wheel cover 13 of the vehicle wheel structure 10 according to the present embodiment includes a diversion mechanism 14.

Here, the side of the wheel 11 on which a vehicle body Bo (see FIG. 2) of the vehicle is located when the wheel 11 is assembled into the vehicle will be referred to as an “inner side” and the opposite side on which the vehicle body Bo is not located will be referred to as an “outer side”. In addition, the following description refers to the direction parallel with a rotation axis L passing through the center of the wheel 11 as an “axial direction” and refers to the direction orthogonal to the rotation axis L as a “radial direction”. In addition, the following description refers to the direction along the front-rear direction of the vehicle as a “front-rear direction”.

The wheel 11 includes an alloy of aluminum or the like or includes steel. The wheel 11 includes a disk 111 formed to have a plate shape and a rim 112 that is provided on the outer circumference of the disk 111 to have an annular shape and holds the tire 12 on the outer circumferential surface. It is to be noted that the present embodiment exemplifies a case where the wheel 11 includes an alloy of aluminum or the like, and the disk 111 and the rim 112 are of a one-piece type in which the disk 111 and the rim 112 are integrally formed as illustrated in FIG. 2.

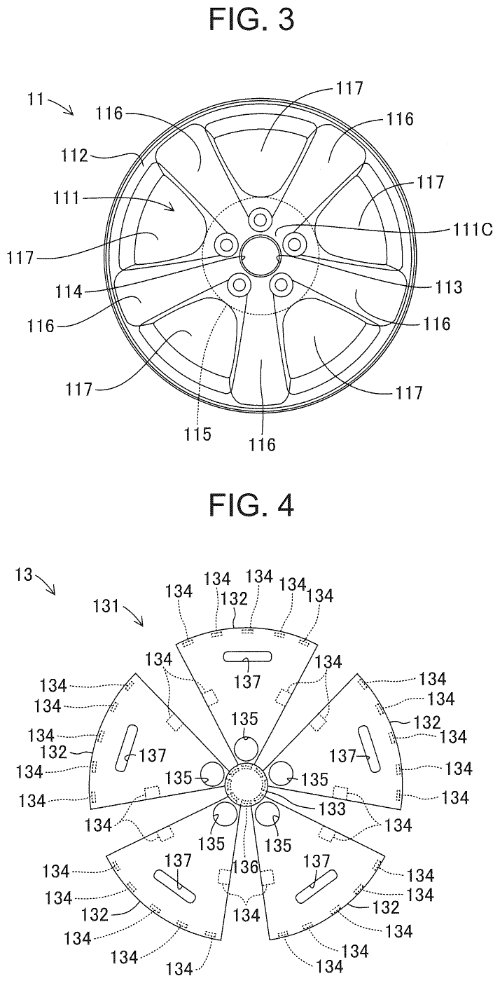

As illustrated in each of FIGS. 2 and 3, the disk 111 has a hub hole 113 that is formed to extend through a middle section 111C of the disk 111 along the rotation axis L. Here, for example, in a case where the wheel cover 13 is not mounted, it is also possible for the hub hole 113 to function as a hole that allows an ornament provided to the wheel 11 to be attached. It is to be noted that the present embodiment exemplifies the hub hole 113 provided to extend through the middle section 111C, but the hub hole 113 does not have to extend through the middle section 111C.

The inner circumferential surface of the hub hole 113 is provided with engagement target sections 114 that engage with engagement sections 136 of the wheel cover 13 described below. The engagement target sections 114 are protrusions formed over the circumference of the inner circumferential surface of the hub hole 113 at predetermined positions in the hub hole 113 in the axial direction. Additionally, it is possible to use protrusions provided to fix an ornament as the engagement target sections 114.

In addition, the disk 111 includes a hub attachment section 115 that fixes the wheel 11 to a hub H and spokes 116 that couple the hub attachment section 115 and the rim 112. It is to be noted that the present embodiment exemplifies a case where the disk 111 includes the five spokes 116 radially extending from the hub attachment section 115.

In addition, the disk 111 has air openings 117 each formed between the adjacent spokes 116. As illustrated in FIG. 3, the present embodiment exemplifies a case where the disk 111 has the five air openings 117 each defined by the two spokes 116, the hub attachment section 115, and the rim 112. It is to be noted that each of the air openings 117 may be defined, for example, by the two spokes 116 and the rim 112 or by the two spokes 116 and the hub attachment section 115 depending on the disposition and the shapes of the spokes 116. The disk 111 and the rim 112, that is, the wheel 11, are then fixed to the hub H by fastening members T, such as hub nuts or hub bolts, as illustrated in each of FIGS. 1 and 2.

Here, as illustrated in FIG. 2, the inner side of the wheel 11 is provided with a disk brake Br as a braking device. The disk brake Br includes a brake rotor Br1 that integrally rotates with the wheel 11 and a caliper Br2 that pushes a friction member against the brake rotor Br1. It is to be noted that the present embodiment exemplifies a case where the disk brake Br is provided as a braking device, but a drum brake may be provided as a braking device.

The wheel cover 13 included in the vehicle wheel structure 10 is molded by using resin. As illustrated in each of FIGS. 1 and 2, the wheel cover 13 is mounted to cover the air openings 117 provided to the wheel 11 on the design surface that is the surface of the wheel 11 on the outer side. As illustrated in FIG. 4, the wheel cover 13 includes a body section 131 as a main element. The body section 131 is formed to cover the whole of the surface corresponding to the outer side of the vehicle, that is, the design surface, with the wheel cover 13 mounted on the disk 111 of the wheel 11. Here, the surface of the body section 131 located on the outer side is decorated in some cases.

The body section 131 includes a plurality of body formation members 132 and a coupling section 133 that couples the body formation members 132 along the circumferential direction of the disk 111 when mounted on the wheel 11. This causes the body formation members 132 to be integrated by the coupling section 133. The body section 131 having a plate shape is mounted on the design surface of the disk 111 of the wheel 11.

Here, the following description exemplifies a case where the body section 131 includes the body formation members 132 each having a fan shape. Specifically, the body section 131 includes the five body formation members 132 to cover the five respective air openings 117 provided to the disk 111 of the wheel 11. It is to be noted that the number of body formation members 132 is not limited to the example. It is sufficient if the number of body formation members 132 is one or more. In addition, the shape of each of the body formation members 132 is not also limited to a fan shape and it is possible to adopt various shapes.

In addition, the following description exemplifies a case where the coupling section 133 couples the (five) body formation members 132 in the middle section 111C of the disk 111 when mounted on the wheel 11. However, needless to say, it is also possible for the coupling section 133 to couple the body formation members 132 at a position other than the middle section 111C of the disk 111, for example, depending on the shape of the disk 111 of the wheel 11 or the three-dimensional shapes of the spokes 116 if described in more detail. Even in the case, the body formation members 132 are integrated by the coupling section 133 and it is possible to mount the body section 131 having a plate shape on the disk 111 of the wheel 11.

The wheel cover 13 includes fixation members 134, such as clips, that fix the body section 131, that is, the respective body formation members 132, to the disk 111. As illustrated in FIG. 2, the fixation members 134 are each hung on the spoke 116 of the disk 111 or are each inserted into and engages with a groove provided to the outer circumferential portion of the rim 112. The respective body formation members 132 or the body section 131 is hereby fixed to the disk 111 of wheel 11.

In addition, the wheel cover 13 has working holes 135 provided to the body section 131, that is, the body formation members 132. As described above, the fastening members T (hub nuts or hub bolts) that assemble the wheel 11 into the hub H are inserted through the working holes 135 to allow for fastening operations. As illustrated in FIG. 2, each of the working holes 135 is a through-hole formed along the axial direction.

In addition, the wheel cover 13 includes the engagement sections 136 that are inserted to the hub hole 113 provided in the middle section 111C of the disk 111 of the wheel 11 and engage with the engagement target sections 114 provided to the hub hole 113. The engagement sections 136 are each provided at the tip of a leg section extending toward the hub hole 113 when the wheel cover 13 is mounted on the wheel 11. That is, the engagement section 136 is provided at the tip of a leg section extending from the coupling section 133 toward the inner side along the axial direction (rotation axis L) with the wheel cover 13 mounted. It is to be noted that the (e.g., eight) engagement sections 136 are provided to the coupling section 133 to form an annular shape as illustrated in FIG. 4.

Each of the engagement sections 136 is formed, for example, in the shape of a lug to engage with the engagement target section 114 that is a protrusion. This causes the engagement section 136 to abut the engagement target section 114 when inserted to the hub hole 113 in the axial direction along with the leg section. The leg section is then resiliently deflected toward the inside in the radial direction when further inserted. This causes the engagement section 136 to get over the engagement target section 114 and engage with the engagement target section 114.

It is to be noted that the present embodiment exemplifies a case where the engagement target sections 114 which are protrusions provided to the hub hole 113 and the engagement sections 136 engage to fix the wheel cover 13 to the disk 111 of the wheel 11. The hub hole 113 is not, however, provided with the engagement target sections 114 that are protrusions in some cases. In the case, there may be provided, for example, cylinders each set to have such a length that prevents the cylinders from being pulled out from the hub hole 113 when inserted to the hub hole 113 instead of the engagement section 136. The wheel cover 13 may be fixed to the disk 111 of the wheel 11 by inserting the cylinders to the hub hole 113.

Furthermore, as described in detail below, the wheel cover 13 according to the present embodiment is provided with through-holes 137 in the body section 131, that is, the respective body formation members 132, to discharge air moved by flows of air diverted by the diversion mechanisms 14, in other words, weakened flows of air, to the outer side of the vehicle. That is, as described below, the body formation members 132 are also used as second members 142 of the diversion mechanisms 14 in the present embodiment. Therefore, the through-holes 137 provided to the body formation members 132 also function as outlets 145 of the diversion mechanisms 14 in the present embodiment as described below.

Each of the diversion mechanisms 14 is a mechanism that is provided to the wheel cover 13 and obstructs a flow of air directed from the inner side of the vehicle to the outer side of the vehicle to divert and weaken the flow of air. The diversion mechanism 14 then discharges, to the outer side of the vehicle, air moved by the flow of air weakened by being diverted, that is, the obstructed flow of air.

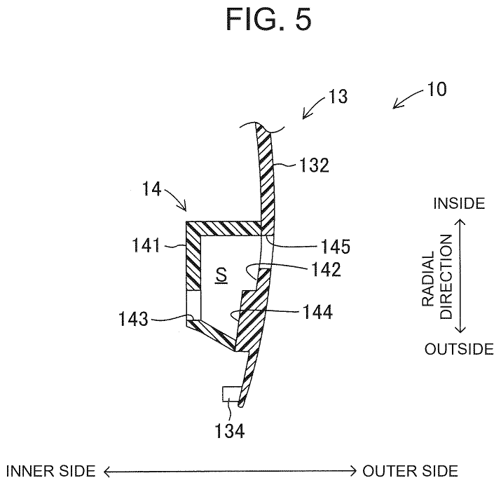

Therefore, the diversion mechanism 14 includes a first member 141 and the second member 142 each molded by using a resin material as illustrated in FIG. 5. In the present embodiment, the first member 141 has a substantially C-shaped cross section as illustrated in FIG. 5. The first member 141 is molded as a different entity from the wheel cover 13. In addition, in the present embodiment, the second member 142 is molded to serve as the body section 131 of the wheel cover 13. More specifically, the second member 142 is molded to serve as the back surface (the surface located on the inner side when the second member 142 is mounted on the disk 111) of the body formation member 132. That is, in the present embodiment, the second member 142 is molded to be also used as the body formation member 132 (body section 131).

In the present embodiment, the first member 141 is then assembled into the second member 142, that is, the body formation member 132, to form the diversion mechanism 14. It is to be noted that the first member 141 and the second member 142 (body formation member 132) are assembled together, for example, by bonding (welding), fitting, engagement, or the like.

The diversion mechanisms 14 are housed in the air openings 117 of the wheel 11 with the wheel cover 13 mounted on the wheel 11 (see FIGS. 1 and 2). This causes each of the diversion mechanisms 14 to divert, for example, air including brake cooling air flowing into the air opening 117 in contact with the disk brake Br, that is, a flow of air directed from the inner side of the vehicle to the outer side of the vehicle.

The first members 141 are disposed on the inner side of the vehicle when housed in the air openings 117. The second members 142 are disposed closer to the outer side of the vehicle than the first members 141 with intervals when housed in the air openings 117.

In addition, each of the diversion mechanisms 14 has an inlet 143. The inlet 143 is provided to the first member 141 to lead air moved by a flow of air directed from the inner side of the vehicle to the outer side of the vehicle in the air opening 117 into a space S formed between the first member 141 and the second member 142.

In addition, each of the diversion mechanisms 14 includes an obstruction section 144. The obstruction section 144 obstructs a flow of air led into the space S from the inlet 143. That is, the obstruction section 144 serves as a resistance to (gets in the way of) or deflects the led flow of air to obstruct the flow of air directed from the inner side of the vehicle to the outer side of the vehicle. In the present embodiment, the obstruction section 144 is provided to the second member 142, that is, the body formation member 132, to face the inlet 143 in the axial direction of the wheel 11.

Furthermore, each of the diversion mechanisms 14 has an outlet 145. The outlet 145 is provided to the second member 142 to lead air moved by a flow of air obstructed by the obstruction section 144 to the outer side of the vehicle. Here, the present embodiment exemplifies a case where the second member 142 is provided to be integrated with the body formation member 132. Thus, in the present embodiment, the outlet 145 serves as the through-hole 137 provided to the body formation member 132. That is, the through-hole 137 is (also) used as the outlet 145.

In the present embodiment, the inlet 143 and the outlet 145 are provided such that a distance R1 and a distance R2 from the center of the wheel 11, that is, the rotation axis L, are different in the radial direction of the wheel 11 as illustrated in FIG. 2. Specifically, in the present embodiment, the inlet 143 and the outlet 145 are disposed such that the distance R1 from the center of the wheel 11 to the inlet 143 is greater than the distance R2 from the center of the wheel 11 to the outlet 145. That is, in the present embodiment, the inlet 143 and the outlet 145 are provided not to overlap in the axial direction of the wheel 11.

Furthermore, in the present embodiment, the outlet 145 (through-hole 137) is provided to be spaced apart from the rim 112 that supports the tire 12 toward to the center of the wheel 11 in the radial direction of the wheel 11 by a predetermined distance K as illustrated in FIG. 2. Here, the predetermined distance K is a distance determined such that, when air is led to the outer side of the vehicle from the outlet 145 (through-hole 137), the led air flows apart from a sidewall 121 of the tire 12, that is, the led air does not spur a vortex generated near the sidewall 121, as described below.

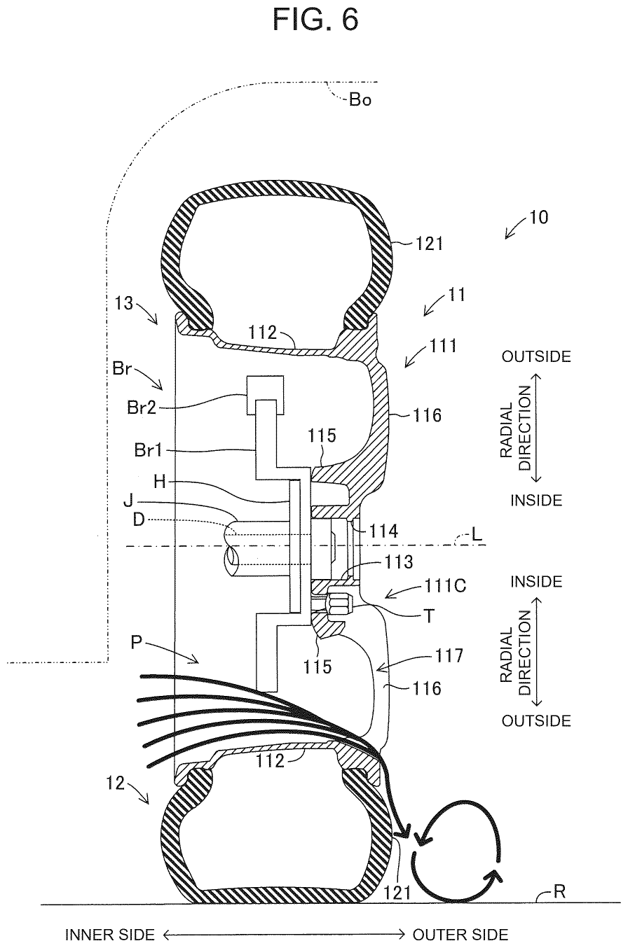

Next, air led by each of the diversion mechanisms 14 to the outer side of the vehicle will be described. In a case where the vehicle travels, air coming under the floor of the vehicle body Bo from the front side in the front-rear direction is compressed between the floor of the vehicle body Bo and a road surface R as illustrated in FIG. 6. Part of the air is hereby moved by a flow of air directed from the inner side to the outer side of the tire-wheel assembly, that is, the wheel 11. The air moved toward the outer side is then further moved toward the outer side from the disk brake Br as “brake cooling air” while cooling the brake rotor Br1 of the disk brake Br that is a braking device disposed in the path of the movement.

In the case, air (brake cooling air) flowing from the inner side to the outer side strongly passes through each of the air openings 117 of the wheel 11 on which the wheel cover 13 is not mounted, in particular, on the lower side of the rim 112 in the perpendicular direction as illustrated by thick solid arrows in FIG. 6. The air (brake cooling air) passing through the air opening 117 then flows along the sidewall 121 of the tire 12. In addition, when the vehicle travels, the tire 12 pushes the air on the road surface R to the right and left to cause a horseshoe-shaped vortex (a so-called horseshoe vortex) to be formed in some cases as illustrated by thick solid arrows in FIG. 6. In the case, the air (brake cooling air) passing through the air opening 117 and flowing along the sidewall 121 of the tire 12 spurs the formation and growth of the horseshoe vortex in some cases.

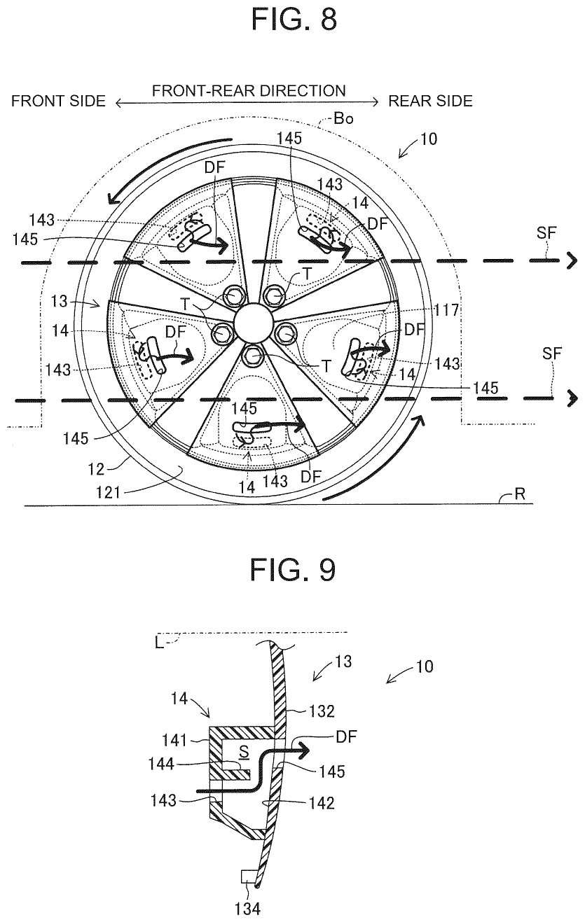

The horseshoe vortex spurred by the air (brake cooling air) discharged to the outer side via the air opening 117 may, however, increase air resistance by interfering with a side flow SF (see FIG. 8) on a side surface of the traveling vehicle. To restrain the horseshoe vortex from being spurred, it is thus necessary to reduce air strongly discharged to the outer side of the wheel 11 via the air opening 117 while moving the air (brake cooling air) from the inner side to the outer side, in particular, on the lower side of the rim 112 in the perpendicular direction.

Accordingly, the vehicle wheel structure 10 includes the diversion mechanisms 14 that each cause the wheel cover 13 to divert air (brake cooling air) moved by a flow of air directed from the inner side to the outer side of the wheel 11 to allow the flow of air directed to the outer side to be weakened. Here, as described above, the wheel cover 13 in the vehicle wheel structure 10 according to the present embodiment includes the diversion mechanisms 14 for the respective body formation members 132 that are the same as the air openings 117 in number. This makes it possible to dispose the diversion mechanisms 14 in association with the respective air openings 117 in a case where the wheel cover 13 is mounted on the wheel 11.

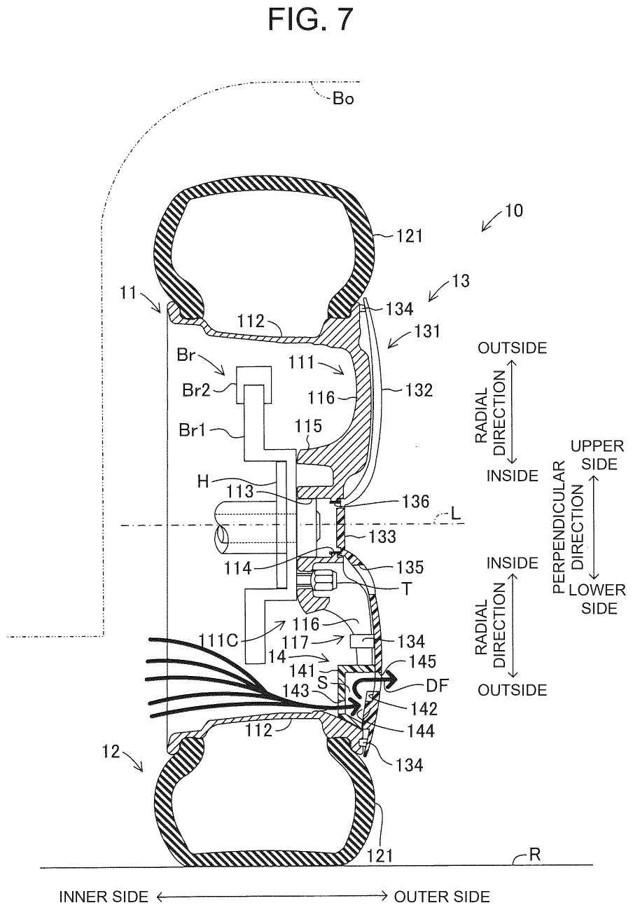

In particular, the diversion mechanism 14 provided to the air opening 117 located on the lower side of the rim 112 in the perpendicular direction when the wheel 11 rotates as illustrated in FIG. 7 hereby leads air (brake cooling air) moved by a flow of air from the inner side of the wheel 11 illustrated by thick solid arrows into the space between the first member 141 and the second member 142, that is, the space S, from the inlet 143. The air (brake cooling air) led from the inlet 143 collides with the obstruction section 144 disposed to face the inlet 143 to cause the flow of air to be obstructed in the diversion mechanism 14. The flow of air is weakened and the direction of the flow of air is deflected to the upper side in the perpendicular direction to point to the outlet 145. The weakened air (brake cooling air) is thus diverted by being deflected and led to the outer side of the wheel 11 from the outlet 145 (through-hole 137).

Here, in the present embodiment, the inlet 143 and the outlet 145 are disposed such that the distance R1 from the center of the wheel 11 to the inlet 143 is greater than the distance R2 from the center of the wheel 11 to the outlet 145 to prevent the inlet 143 and the outlet 145 from overlapping in the axial direction of the wheel 11 (see FIG. 2). In the present embodiment, the outlet 145 (through-hole 137) is then provided to be spaced apart from the rim 112 toward the center of the wheel 11 in the radial direction by the predetermined distance K determined such that the horseshoe vortex is not spurred (see FIG. 2).

This allows, in particular, the diversion mechanism 14 provided to the air opening 117 located on the lower side of the rim 112 in the perpendicular direction to lead air (brake cooling air) moved by a flow of air diverted from the inlet 143 to the outlet 145 via the obstruction section 144 and weakened to the outer side while keeping the air spaced apart from the generated horseshoe vortex. That is, as illustrated in FIG. 8, it is possible for the diversion mechanism 14 provided to the air opening 117 located on the lower side of the rim 112 in the perpendicular direction to direct a discharge flow DF of air (brake cooling air) led to the outer side from the outlet 145 (through-hole 137) to the rear side in the front-rear direction with the side flow SF. It is thus possible, in particular, for the diversion mechanism 14 provided to the air opening 117 located on the lower side of the rim 112 in the perpendicular direction to restrain the formation of a horseshoe vortex from being spurred. As a result, the growth of the horseshoe vortex is restrained and it is possible to restrain air resistance from increasing because of the interference between the horseshoe vortex and the side flow SF.

In addition, it is possible for the diversion mechanism 14 provided to the air opening 117 corresponding to the lower side of the rim 112 in the perpendicular direction to weaken a flow of air and lead the air (brake cooling air) to the outer side. It is therefore possible to reduce interference with the side flow SF, for example, in comparison with a case where the wheel cover 13 is not provided with the diversion mechanism 14 and the flow of air is not weakened. This also makes it possible to restrain air resistance from increasing.

In addition, air moved by a flow of air directed from the inner side to the outer side of the wheel 11 comes into the space S from the inlet 143 in some cases in the diversion mechanism 14 provided to the air opening 117 other than the air opening 117 located on the lower side of the rim 112 in the perpendicular direction. In the case, it is also possible for each of the diversion mechanisms 14 to lead, to the outer side, the air (brake cooling air) moved by the flow of air diverted from the inlet 143 to the outlet 145 via the obstruction section 144 and weakened as described above. That is, in the case, it is also possible to for each of the diversion mechanisms 14 to direct the discharge flow DF of air (brake cooling air) led to the outer side from the outlet 145 (through-hole 137) to the rear side in the front-rear direction with the side flow SF as illustrated in FIG. 8.

This makes it possible to reduce interference with the side flow SF, for example, in comparison with a case where the wheel cover 13 is not provided and air (brake cooling air) is not weakened because the diversion mechanism 14 provided to the air opening 117 other than the air opening 117 located on the lower side of the rim 112 in the perpendicular direction also weakens and discharges the air (brake cooling air) to the outer side. This also makes it possible to restrain air resistance from increasing.

As can be understood from the description above, the vehicle wheel structure 10 includes the wheel 11 that supports the tire 12 and is assembled into the vehicle and the wheel cover 13 as a wheel mounting member that is mounted on the wheel 11. The wheel cover 13 mounted on the wheel 11 assembled into the vehicle includes the diversion mechanism 14. The diversion mechanism 14 includes the first member 141, the second member 142 (body formation member 132), the inlet 143, the obstruction section 144, and the outlet 145. The first member 141 is disposed on the inner side of the vehicle. The second member 142 (body formation member 132) is disposed on the outer side of the vehicle with an interval to the first member 141. The inlet 143 is provided to the first member 141 to lead air to a space between the first member 141 and the second member 142 (body formation member 132) in the air opening 117 provided to the disk 111 having a plate shape. The disk forms the wheel 11. The air is moved by a flow of air directed from the inner side of the vehicle to the outer side of the vehicle. The obstruction section 144 obstructs the flow of the air led from the inlet 143. The outlet 145 is provided to the second member 142 to lead the air moved by the flow of air obstructed by the obstruction section 144 to the outer side of the vehicle. In the case, the wheel mounting member 13 is molded by using a resin material.

In addition, in the case, the inlet 143 and the outlet 145 are provided not to overlap in the axial direction of the wheel 11. In the case, the inlet 143 and the outlet 145 are provided to have different distances from the rotation axis L that is the center of the wheel 11 in the radial direction of the wheel 11. In the case, the distances are set such that the distance to the inlet 143 is greater than the distance to the outlet 145.

In addition, in the case, the outlet 145 is provided to be spaced apart from the rim 112 that forms the wheel 11 and supports the tire 12 on the outer circumferential surface toward the center of the wheel 11 in the radial direction of the wheel 11 by the predetermined distance K. The rim 112 has an annular shape. In the case, the predetermined distance K is a distance determined such that, when the air is led to the outer side of the vehicle from the outlet 145, the led air flows apart from the sidewall 121 of the tire 12.

In addition, in the case, the second member 142 is molded to serve as the body section 131 of the wheel cover 13 that covers the whole of the surface of the wheel 11 corresponding to the outer side of the vehicle when mounted on the wheel 11. In the case, the body section 131 includes the body formation members 132 and the coupling section 133 that couples the body formation members 132 along the circumferential direction of the wheel 11 when mounted on the wheel 11. In the case, the coupling section 133 couples the body formation members 132 in the middle section 111C of the wheel 11 when mounted on the wheel 11.

The vehicle wheel structure 10 allows the diversion mechanism 14 provided to the wheel cover 13 to obstruct, by the obstruction section 144, a flow of air led from the inlet 143 provided to the first member 141. That is, it is possible to weaken the flow of air by diverting the air and lead the air to the outer side from the outlet 145 provided to the second member 142. This allows the vehicle wheel structure 10 to restrain the air moved by the flow of air directed from the inner side to the outer side from spurring the formation of a horseshoe vortex that is a vortex generated near the sidewall 121 of the tire 12 closer to the outer side by the traveling vehicle and consequently restrain the horseshoe vortex from interfering with the side flow SF to disturb the side flow SF. The vehicle wheel structure 10 is thus allowed to restrain air resistance acting on the traveling vehicle from increasing and consequently contribute to increases in the fuel efficiency and the electricity efficiency of the vehicle.

### 2. First Modification Example

The embodiment described above exemplifies the case where the obstruction section 144 is provided to be integrated with the second member 142 (i.e., body formation member 132) and be substantially parallel with the planar direction of the second member 142 (body formation member 132) in the diversion mechanism 14. When air moved by a flow of air directed from the inner side to the outer side of the wheel 11 comes into the space S from the inlet 143, the incoming air thus collides with the obstruction section 144 disposed to face the inlet 143 in the embodiment described above. This weakens the flow of incoming air and deflects the flow of incoming air to the upper side in the perpendicular direction. As a result, the air coming from the inlet 143 does not proceed straight and is led to the outer side from the outlet 145 (through-hole 137).

Instead, as illustrated in FIG. 9, it is also possible to provide the first member 141 with the obstruction section 144 by extending the obstruction section 144 along the axial direction parallel with the rotation axis L in the diversion mechanism 14. That is, in the case, the obstruction section 144 is provided to the first member 141 to be parallel with a flow of air coming from the inlet 143.

This causes the obstruction section 144 according to a first modification example to collide with air coming into the space S from the inlet 143 and moved to the upper side in the perpendicular direction by a flow of air directed to the outlet 145 that is caused to be relatively low in pressure, for example, by the side flow SF. This diverts and weakens the flow of air directed to the outlet 145 as illustrated by a thick arrow in FIG. 9 and the incoming air is led to the outer side from the outlet 145 (through-hole 137). Thus, an effect similar to the effect of the embodiment described above is also obtained in the case of the first modification example.

### 3. Second Modification Example

The embodiment and the first modification example described above each exemplify the case where the diversion mechanism 14 is provided with the inlet 143 and the outlet 145 such that the distance R1 and the distance R2 from the rotation axis L are different. That is, the present embodiment and the first modification example described above each exemplify the case where the inlet 143 and the outlet 145 are provided not to overlap in the axial direction of the wheel 11.

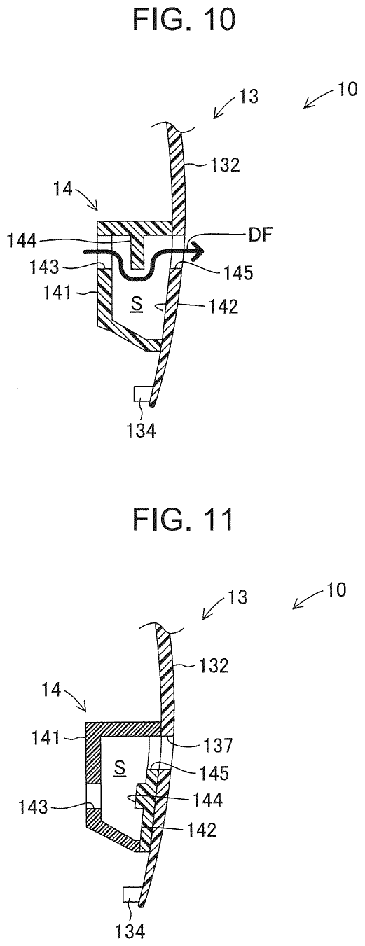

Instead, as illustrated in FIG. 10, it is also possible to provide the diversion mechanism 14 with the inlet 143 and the outlet 145 such that the distance R1 and the distance R2 from the rotation axis L are the same and the inlet 143 and the outlet 145 overlap in the axial direction of the wheel 11. That is, in a second modification example, the inlet 143 and the outlet 145 of the diversion mechanism 14 are provided to face each other in the axial direction.

In the case, the obstruction section 144 according to the second modification example is then provided to the first member 141 to be located between the inlet 143 and the outlet 145 in the axial direction of the wheel 11 such that a flow of air coming into the space S from the inlet 143 is diverted and weakened, and directed to the outlet 145. This causes the obstruction section 144 according to the second modification example to collide with the air coming into the space S from the inlet 143 and proceeding straight as illustrated by a thick arrow in FIG. 10. The flow of air directed to the outlet 145 is thus diverted around the obstruction section 144 and is weakened. The incoming air is discharged to the outer side from the outlet 145 (through-hole 137). Thus, an effect similar to the effect of the embodiment described above is also obtained in the case of the second modification example.

### 4. Third Modification Example

The embodiment, the first modification example, and the second modification example described above each exemplify the case where the body section 131, that is, the body formation member 132, of the wheel cover 13 is (also) used as the second member 142 of the diversion mechanism 14. The embodiment described above thus exemplifies the case where the obstruction section 144 is integrally formed on the back surface side of the body formation member 132 and the body formation member 132 is provided with the through-hole 137 serving as the outlet 145.

Instead, as illustrated in FIG. 11, it is also possible to mold the diversion mechanism 14 as a different entity from the wheel cover 13 and assemble the diversion mechanism 14 into the body formation member 132 of the wheel cover 13. It is to be noted that FIG. 11 illustrates the diversion mechanism 14 according to the embodiment described above as a representative, but it is also possible to mold each of the diversion mechanisms 14 according to the first modification example and the second modification example described above as a different entity from the wheel cover 13 and assemble the diversion mechanism 14 into the body formation member 132 of the wheel cover 13.

In the case, an effect similar to the effects of the embodiment, the first modification example, and the second modification example described above is offered by assembly that provides communication between the outlet 145 of the diversion mechanism 14 and the through-hole 137 provided to the body formation member 132 (body section 131) of the wheel cover 13. Additionally, in the case, as long as it is possible to provide communication between the outlet 145 and the through-hole 137, assembly is not necessary that causes the position of the outlet 145 to coincide with the position of the through-hole 137. For example, assembly may be adopted that shifts the positions of the outlet 145 and the through-hole 137 in the radial direction or the circumferential direction of the wheel 11. In the case, it is also possible to weaken a flow of air and lead the air to the outer side of the vehicle.

In addition, FIG. 11 exemplifies the case where the first member 141 having the inlet 143 is molded, the second member 142 including the obstruction section 144 and the outlet 145 is molded, and the diversion mechanism 14 assembled by using the molded first member 141 and second member 142 is assembled into the wheel cover 13 to mold the diversion mechanism 14, for example, for the purpose of facilitating resin molding. The molding is not, however, limited to the example. It is also possible to integrally mold the first member 141, the second member 142, the inlet 143, the obstruction section 144, and the outlet 145.

### 5. Fourth Modification Example

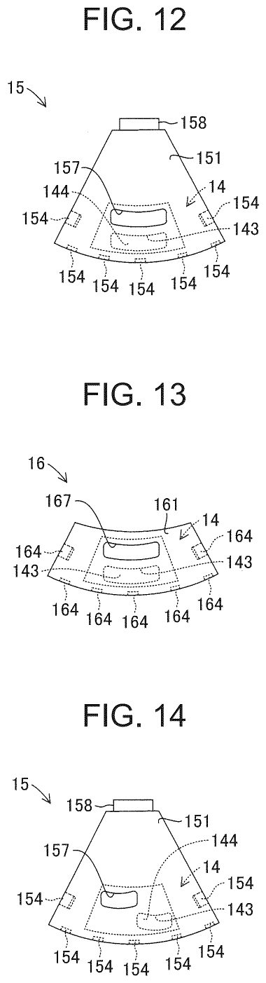

The embodiment and the first modification example to the third modification example described above each exemplify the wheel cover 13 serving as a wheel mounting member in which the (e.g., five) body formation members 132 that form the body section 131 are coupled by the coupling section 133. Instead, it is also possible to mount an accessory piece 15 similar to each of the body formation members 132 according to the embodiment or the like described above on the wheel 11 as a wheel mounting member to fill the air opening 117 of the wheel 11 as illustrated in FIG. 12.

The accessory piece 15 includes a body section 151, fixation members 154, and a through-hole 157. Here, the body section 151, the fixation members 154, and the through-hole 157 are respectively the same components as the body formation member 132, the fixation members 134, and the through-hole 137 described in the embodiment or the like described above. The body section 151, the fixation members 154, and the through-hole 157 will not be thus described.

In addition, the accessory piece 15 includes a fitting section 158 that fits into the spoke 116 on the side of the spoke 116 closer to the hub attachment section 115. This causes, for example, the fitting section 158 to fit into the hub attachment section 115 and subsequently engages the fixation members 154 with the spoke 116 and the rim 112 of the wheel 11 to mount (fix) the accessory piece 15 on (to) the disk 111 of the wheel 11.

As described above, the accessory piece 15 illustrated in FIG. 12 is also provided with the diversion mechanism 14 as in the embodiment or the like described above. It is to be noted that a fourth modification example exemplifies, as a representative, a case where the inlet 143 and the outlet 145 are provided to the diversion mechanism 14 not to overlap in the axial direction of the wheel 11 as in the embodiment, the first modification example, and the third modification example described above. The inlet 143 and the outlet 145 may be, however, provided to the diversion mechanism 14 to overlap in the axial direction of the wheel 11 as in the second modification example described above.

In a case where the accessory piece 15 is mounted on the wheel 11, it is also possible for the diversion mechanism 14 to divert and weaken air moved by a flow of air directed from the inner side to the outer side of the wheel 11 to discharge the air to the outer side from the outlet 145, that is, the through-hole 157 as in the embodiment or the like described above. Thus, an effect similar to the effect of the embodiment or the like described above is also obtained in the fourth modification example.

### 6. Fifth Modification Example

The fourth modification example described above exemplifies the accessory piece 15 including the body section 151 molded depending on the shape of the air opening 117 to cover the whole of the air opening 117 of the wheel 11. As described in the embodiment described above, air moved by a flow of air directed from the inner side to the outer side of the wheel 11 is, however, air compressed under the floor and flowing toward the wheel 11 along with the traveling vehicle. As illustrated in each of FIGS. 6 and 7, most of the air moves along the inner circumferential surface of the rim 112 on the lower side of the rim 112 in the perpendicular direction. Therefore, it is also possible to mount an accessory piece 16 that allows the side of the air opening 117 closer to the rim 112 alone to be covered as illustrated in FIG. 13 on the air opening 117 of the wheel 11 as a wheel mounting member instead of covering the whole of the air opening 117. That is, it is possible to mount the band-shaped accessory piece 16 on the air opening 117 of the wheel 11 as a wheel mounting member.

The accessory piece 16 includes a body section 161, fixation members 164, and a through-hole 167 as with the accessory piece 15 according to the fourth modification example described above. The body section 161 is molded to have a band shape as illustrated in FIG. 13. The body section 161 is molded to be wider from the rim 112 toward the center of the wheel 11 in the radial direction than the predetermined distance K determined not to spur a horseshoe vortex when mounted on the air opening 117 of the wheel 11. Here, the fixation members 164 and the through-hole 167 are respectively the same components as the fixation members 134 and the through-hole 137 described in the embodiment or the like described above. The fixation members 164 and the through-hole 167 will not be thus described.

As described above, the accessory piece 16 illustrated in FIG. 13 is also provided with the diversion mechanism 14 as in the embodiment or the like described above. It is to be noted that a fifth modification example also exemplifies, as a representative, a case where the inlet 143 and the outlet 145 are provided to the diversion mechanism 14 not to overlap in the axial direction of the wheel 11 as in the embodiment, the first modification example, and the third modification example described above. The inlet 143 and the outlet 145 may be, however, provided to the diversion mechanism 14 to overlap in the axial direction of the wheel 11 as in the second modification example described above.

In a case where the accessory piece 16 is mounted on the air opening 117 of the wheel 11, it is possible for the diversion mechanism 14 to preferentially or selectively divert air moved by such a flow of air along the inner circumferential surface of the rim 112 that spurs the formation of a horseshoe vortex and weaken the flow of air, and lead the air to the outer side from the outlet 145, that is, the through-hole 167. Thus, in the fifth modification example, it is possible to weaken, in particular, such a flow of air along the inner circumferential surface of the rim 112 that spurs the formation of a horseshoe vortex and restrain air resistance from increasing along with the formation of a horseshoe vortex.

### 7. Other Modification Examples

The embodiment and the respective modification examples described above each exemplify and describe the cases where the inlet 143 and the outlet 145 of the diversion mechanism 14 overlap and do not overlap in the same radial direction. That is, the embodiment and the respective modification examples described above each exemplify the case where the respective positions of the inlet 143 and the outlet 145 in the circumferential direction are positions in the same radial direction.

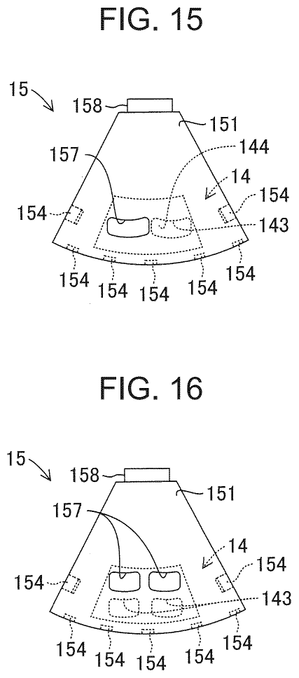

Instead, as FIG. 14 exemplifies the accessory piece 15, it is also possible to provide the inlet 143 and the outlet 145 of the diversion mechanism 14 such that the distance R1 and the distance R2 from the rotation axis L are different and the inlet 143 and the outlet 145 are shifted in the circumferential direction. In addition, as FIG. 15 exemplifies the accessory piece 15, it is also possible to provide the inlet 143 and the outlet 145 of the diversion mechanism 14 such that the distance R1 and the distance R2 from the rotation axis L are the same and the inlet 143 and the outlet 145 are shifted in the circumferential direction.

As described above, even in a case where the diversion mechanism 14 is provided with the inlet 143 and the outlet 145, it is possible to divert air moved by a flow of air directed from the inner side to the outer side of the wheel 11 and weaken the flow of air, and lead the air to the outer side from the outlet 145. Thus, effects similar to the effect of the embodiment or the like described above are also obtained in the cases.

Furthermore, the embodiment and the respective modification examples described above each exemplify and describe the case where the one inlet 143 and the one outlet 145 of the diversion mechanism 14 are provided. Instead, as FIG. 16 exemplifies the accessory piece 15, it is also possible to provide the inlets 143 and the outlets 145 of the diversion mechanism 14 along the circumferential direction. As described above, even in a case where the diversion mechanism 14 is provided with the inlets 143 and the outlets 145 along the circumferential direction, it is possible to divert air moved by a flow of air directed from the inner side to the outer side of the wheel 11 and weaken the flow of air, and lead the air to the outer side from each of the outlets 145. Thus, an effect similar to the effect of the embodiment or the like described above is also obtained in the case.

Here, a vehicle wheel structure according to a first aspect of the present disclosure including: a wheel configured to support a tire, the wheel being assembled into a vehicle; and a wheel mounting member mounted on the wheel, in which the wheel mounting member mounted on the wheel assembled into the vehicle includes a diversion mechanism, the diversion mechanism including a first member disposed on the inner side of the vehicle, a second member disposed on the outer side of the vehicle with an interval to the first member, an inlet provided to the first member to lead air to a space between the first member and the second member in an air opening provided to a disk having a plate shape, the disk forming the wheel, the air being air moved by a flow of air directed from the inner side of the vehicle to the outer side of the vehicle, an obstruction section configured to obstruct the flow of the air led from the inlet, and an outlet provided to the second member to lead the air moved by the flow of air obstructed by the obstruction section to the outer side of the vehicle.

In addition, a vehicle wheel structure according to a second aspect of the present disclosure is the vehicle wheel structure according to the first aspect in which the inlet and the outlet are provided not to overlap in the axial direction of the wheel.

In addition, a vehicle wheel structure according to a third aspect of the present disclosure is the vehicle wheel structure according to the second aspect in which the inlet and the outlet are provided to have different distances from the center of the wheel in the radial direction of the wheel.

In addition, a vehicle wheel structure according to a fourth aspect of the present disclosure is the vehicle wheel structure according to the third aspect in which the distances are set such that the distance to the inlet is greater than the distance to the outlet.

In addition, a vehicle wheel structure according to a fifth aspect of the present disclosure is the vehicle wheel structure according to any one of the first to fourth aspects in which the inlets and the outlets are each formed along the circumferential direction of the wheel.

In addition, a vehicle wheel structure according to a sixth aspect of the present disclosure is the vehicle wheel structure according to any one of the first to fifth aspects in which the outlet is provided to be spaced apart from a rim that forms the wheel and is configured to support the tire on the outer circumferential surface toward the center of the wheel in the radial direction of the wheel by a predetermined distance, the rim having an annular shape.

In addition, a vehicle wheel structure according to a seventh aspect of the present disclosure is the vehicle wheel structure according to the sixth aspect in which the predetermined distance is a distance determined such that, when the air is led to the outer side of the vehicle from the outlet, the led air flows apart from a sidewall of the tire.

In addition, a vehicle wheel structure according to an eighth aspect of the present disclosure is the vehicle wheel structure according to the first aspect in which the obstruction section is provided to be located between the inlet and the outlet in the axial direction of the wheel.

In addition, a vehicle wheel structure according to a ninth aspect of the present disclosure is the vehicle wheel structure according to any one of the first to eighth aspects in which the second member is molded to serve as a body section of the wheel mounting member that covers the whole of the surface of the wheel corresponding to the outer side of the vehicle when mounted on the wheel.

In addition, a vehicle wheel structure according to a tenth aspect of the present disclosure is the vehicle wheel structure according to the ninth aspect in which the body section includes a plurality of body formation members and a coupling section configured to couple the body formation members along the circumferential direction of the wheel when mounted on the wheel.

In addition, a vehicle wheel structure according to an eleventh aspect of the present disclosure is the vehicle wheel structure according to the tenth aspect in which the coupling section couples the body formation members in the middle section of the wheel when mounted on the wheel.

In addition, a vehicle wheel structure according to a twelfth aspect of the present disclosure is the vehicle wheel structure according to any one of the first to eleventh aspects in which the wheel mounting member is formed by using a resin material.

What is claimed is:

1. A vehicle wheel structure comprising:
a wheel configured to support a tire, the wheel being assembled into a vehicle; and
a wheel mounting member mounted on the wheel, wherein
the wheel mounting member mounted on the wheel assembled into the vehicle includes a diversion mechanism, the diversion mechanism including
a first member disposed on an inner side of the vehicle,
a second member disposed on an outer side of the vehicle with an interval to the first member,
an inlet provided to the first member to lead air to a space between the first member and the second member in an air opening provided to a disk having a plate shape, the disk being provided to the wheel, the air being air moved by a flow of air directed from the inner side of the vehicle to the outer side of the vehicle,
an obstruction section configured to obstruct the flow of the air led from the inlet, and
an outlet provided to the second member to lead the air moved by the flow of air obstructed by the obstruction section to the outer side of the vehicle.

2. The vehicle wheel structure according to claim 1, wherein the inlet and the outlet are provided not to overlap in an axial direction of the wheel.

3. The vehicle wheel structure according to claim 2, wherein the inlet and the outlet are provided to have different distances from a center of the wheel in a radial direction of the wheel.

4. The vehicle wheel structure according to claim 3, wherein the distances are set such that the distance to the inlet is greater than the distance to the outlet.

5. The vehicle wheel structure according to claim 1, wherein the inlets and the outlets are each provided along a circumferential direction of the wheel.

6. The vehicle wheel structure according to claim 1, wherein the outlet is provided to be spaced apart from a rim provided to the wheel and configured to support the tire on an outer circumferential surface toward a center of the wheel in a radial direction of the wheel by a predetermined distance, the rim having an annular shape.

7. The vehicle wheel structure according to claim 6, wherein the predetermined distance is a distance determined such that, when the air is led to the outer side of the vehicle from the outlet, the led air flows apart from a sidewall of the tire.

8. The vehicle wheel structure according to claim 1, wherein the obstruction section is provided to be located between the inlet and the outlet in an axial direction of the wheel.

9. The vehicle wheel structure according to claim 1, wherein the second member is provided to serve as a body section of the wheel mounting member provided to cover a whole of a surface of the wheel corresponding to the outer side of the vehicle when mounted on the wheel.

10. The vehicle wheel structure according to claim 9, wherein the body section includes a plurality of body formation members and a coupling section configured to couple the body formation members along a circumferential direction of the wheel when mounted on the wheel.

11. The vehicle wheel structure according to claim 10, wherein the coupling section couples the body formation members in a middle section of the wheel when mounted on the wheel.

12. The vehicle wheel structure according to claim 1, wherein the wheel mounting member is formed by using a resin material.
